(19) United States
(12) Patent Application Publication
(10) Pub. No.: US 2003/0157853 A1
(43) Pub. Date: Aug. 21, 2003

(54) Composite fabric material

(75) Inventor: Richard S. Huber, Coeur d'Alene, ID (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Advanced Sports Fabrics, Ltd.

(21) Appl. No.: 10/346,717

(22) Filed: Jan. 16, 2003

Related U.S. Application Data
(60) Provisional application No. 60/349,827, filed on Jan. 17, 2002.
(60) Provisional application No. 60/413,789, filed on Sep. 26, 2002.

(51) Int. Cl. B32B 1/02

(52) U.S. Cl. 442/76; 428/36.1

(57) ABSTRACT

Composite fabrics for waterproof applications are disclosed. In one embodiment, the composite fabric material includes a middle section of three-dimensional fabric with a first surface and a second surface. A first barrier layer is proximate to the first surface and is substantially impermeable to water vapor and liquid water. A second barrier layer is proximate the second surface and is substantially impermeable to water vapor and liquid water.

### CROSS-REFERENCES TO RELATED APPLICATIONS

This non-provisional patent application claims the benefit of the filing dates of U.S. Provisional Patent Application No. 60/349,827, filed on Jan. 17, 2002, and U.S. Provisional Patent Application No. 60/413,789 filed on Sep. 26, 2002. Both of these U.S. Provisional Patent Applications are herein incorporated by reference in their entirety.

### BACKGROUND OF THE INVENTION

Many wetsuits in commercial use today are made of neoprene. While neoprene is useful, neoprene is bulky and inflexible. A wearer has a hard time moving around in a neoprene wetsuit. Neoprene also has poor insulating properties and is not environmentally friendly.

Neoprene-free composite materials have been described. One neoprene-free composite material has a woven fabric that is sandwiched between two layers that are permeable to water vapor. The permeability is for the comfort of the wearer. However, using water vapor permeable layers in a wetsuit has disadvantages. For example, when the wetsuit composite fabric material is permeable to water vapor, water vapor can condense within the wetsuit composite fabric material. The condensed water within the wetsuit fabric material could cause any fabric material in between the two vapor permeable layers to rot. This can decrease the lifetime of the wetsuit composite fabric material. Mold could also grow in between the two vapor permeable layers. This can cause health problems in the wearer if the wearer is allergic to molds. The wet environment inside of the wetsuit composite fabric material can also be a breeding ground for pathogens, which can also cause health problems in the wearer.

Embodiments of the invention address these and other problems.

### SUMMARY OF THE INVENTION

Embodiments of the invention include composite fabric materials, particularly for use in waterproof garments such as wetsuits. Embodiments of the invention have improved thermal insulation and elasticity. They can also be lightweight, durable and impermeable to liquid water and water vapor. The composite fabric material can also have a low elastic modulus so a person wearing it can move in comfort.

One embodiment of the invention is directed to a composite fabric material comprising: a middle section comprising a three-dimensional fabric structure with a first surface and a second surface; a first barrier layer proximate the first surface, wherein the first barrier layer is substantially impermeable to water vapor and liquid water; and a second barrier layer proximate the second surface, wherein the second barrier layer is substantially impermeable to water vapor and liquid water.

Another embodiment of the invention is directed to a composite fabric material comprising: a middle section comprising a two-dimensional fabric including a first surface and a second surface; a first barrier layer which is substantially impermeable to water vapor and liquid water and is adhered to the first surface; and a second barrier layer that is substantially impermeable to water vapor and liquid water and is adhered to the second surface, wherein the composite fabric material is substantially free of neoprene.

Another embodiment of the invention is directed to a composite fabric material comprising: (a) a middle section comprising a three-dimensional fabric with a first surface and a second surface and comprising elastomeric fibers; (b) a first elastic barrier layer proximate the first surface, wherein the first elastic barrier layer is impermeable to water vapor and liquid water; (c) a second elastic barrier layer proximate the second surface, wherein the second elastic barrier layer is impermeable to water vapor and liquid water; (d) a first adhesive layer coupling the middle section and the first elastic barrier layer; and (e) a second adhesive layer coupling the second elastic barrier layer and the middle section.

Another embodiment of the invention is directed to a waterproof garment comprising: a composite fabric material including (a) a middle section comprising a three-dimensional fabric with a first surface and a second surface and comprising elastomeric fibers, (b) a first elastic barrier layer proximate the first surface, wherein the first elastic barrier layer is impermeable to water vapor and liquid water; (c) a second elastic barrier layer proximate the second surface, wherein the second elastic barrier layer is impermeable to water vapor and liquid water, (d) a first adhesive layer coupling the middle section and the first elastic barrier layer, and (e) a second adhesive layer coupling the second elastic barrier layer and the middle section.

The various invention embodiments have various aspects. Some embodiments have some aspects while other embodiments have all aspects.

One aspect of an invention embodiment is to provide an improved two or three-dimensional knit, woven, or non-woven fabric or combination thereof which is of low modulus.

Another aspect of an invention embodiment is to provide a two or three-dimensional knit, woven or non-woven fabric or combination thereof which has low weight.

Another aspect of an invention embodiment is to provide a two or three-dimensional knit, woven or non-woven fabric or combination thereof which is highly elastic.

Another aspect of an invention embodiment is to provide a two or three-dimensional knit, woven or non-woven fabric or combination thereof with a high air-to-fiber ratio.

Another aspect of an invention embodiment is to provide a barrier layer, which is impermeable to water vapor and liquid water.

Another aspect of an invention embodiment is to provide a barrier layer, which resists damage caused by ultraviolet radiation and is therefore durable.

Another aspect of an invention embodiment is to provide a barrier layer, which is highly elastic.

Another aspect of an invention embodiment is to provide a barrier layer, which has a low elastic modulus.

Another aspect of an invention embodiment is to provide a barrier layer, which has low weight.

Another aspect of an invention embodiment is to provide a composite fabric material, which is highly elastic.

Another aspect of an invention embodiment is to provide a composite fabric material which is has low elastic modulus.

Another aspect of an invention embodiment is to provide a fabric material which resists structural changes when exposed to hydrostatic pressure and has good insulating properties to depths of up to about 100 feet.

Another aspect of an invention embodiment is to provide a composite fabric material, which is puncture and tear resistant, and durable.

Another aspect of an invention embodiment is to provide a composite fabric material which can lower the risk of adverse health effects to the wearer.

These and other embodiments of the invention are described in further detail below with reference to the Figures and Detailed Description.

### BRIEF DESCRIPTION OF THE DRAWINGS

FIG. 1 shows a perspective view of a middle section of an embodiment of the invention comprising multiple two-dimensional knit or woven fabrics bonded together to form a three-dimensional fabric structure.

FIG. 2 shows a perspective view of a middle section of an embodiment of the invention comprising a three-dimensional knit or woven fabric.

FIG. 3 shows a perspective view of a middle section of an embodiment of the invention comprising a non-woven fabric.

FIG. 4 shows a perspective view of the middle section of an embodiment of the invention comprising a two-dimensional fabric and non-woven fabric combination.

FIG. 5 shows a perspective and partial cut-away view of a composite fabric material according to an embodiment of the invention.

FIG. 6 shows a separated view of various layers in another embodiment of the invention.

FIG. 7 shows a schematic drawing of the completed wetsuit fabric material formed into adjoining panels of a garment.

### DETAILED DESCRIPTION

The composite fabric material according to an embodiment of the invention is suitable for use in waterproof garments such as wetsuits, waders and survival suits. It can be used to make gloves, hoods and booties. The composite fabric material and waterproof garments have good insulation properties, good water repellency, and good flexibility. They are also comfortable.

The composite fabric material can include a middle section comprising a fabric that is sandwiched between first and second impermeable barrier layers. The barrier layers and the composite fabric material are substantially impermeable to water vapor or liquid water. Preferably, the barrier layers, the middle section, and the composite fabric material as a whole, are free of neoprene.

The middle section may comprise one or more layers of fabric material to improve the insulating properties of the composite fabric material. For example, the middle section can comprise a two or three-dimensional knitted, woven, or non-woven fabric or combination thereof. In some embodiments, the middle section is a two or three-dimensional knit, woven or non-woven fabric or combination thereof, which provides high elasticity. The middle section is lightweight by virtue of a high air-to-fiber ratio. It can also have a low elastic modulus.

The middle section may have any suitable number of fabric layers. The fabric layers may be bonded together using intervening adhesive layers. The layers could alternatively be melt-bonded together in appropriate circumstances. For example, in some embodiments, the middle section may include only one fabric layer, while in other embodiments, the middle section may include two or more fabric layers. In preferred embodiments, the middle section includes one or more “three-dimensional fabric”,layers. “Three-dimensional fabrics” are described in further detail below. In other embodiments, the middle section may comprise multiple layers of netting, mesh, or solid fibers (alone or in combination with the above mentioned middle section layer combinations) to form a three-dimensional fabric structure.

The first and second barrier layers may be hydrophobic and monolithic. The first and second barrier layers may have the same or different materials and/or thickness. In addition, the first and second barrier layers may comprise any suitable thermoplastic or elastomeric material.

The barrier layers render the composite fabric material substantially impermeable to water vapor and liquid water. The need to maintain a completely dry atmosphere in the middle section the composite fabric material is desirable. If allowed to pass through the barrier layer, the transmitted water vapor will condense and build-up inside the middle section. This condition may, in turn, lead to bacterial and mold attack of the middle section, reducing its lifespan. Sources of moisture include, but are not limited to, a wearer's perspiration and urine. Also, in a warm, pathogen supportive atmosphere, a moist middle section in a composite fabric material may adversely affect the health of the garment wearer. Since the transmission of water vapor through the composite fabric material is substantially blocked in embodiments of the invention, embodiments of the invention are less likely to degrade and are less likely to cause health problems in the wearer than other conventional wetsuit fabric materials.

The composite fabric material according to embodiments of the invention may have any suitable dimensions. In some embodiments, the total thickness of the composite fabric material may be less than about 100 mm. In-other embodiments, the total thickness of the composite fabric material can be between about 2 mm and about 20 mm.

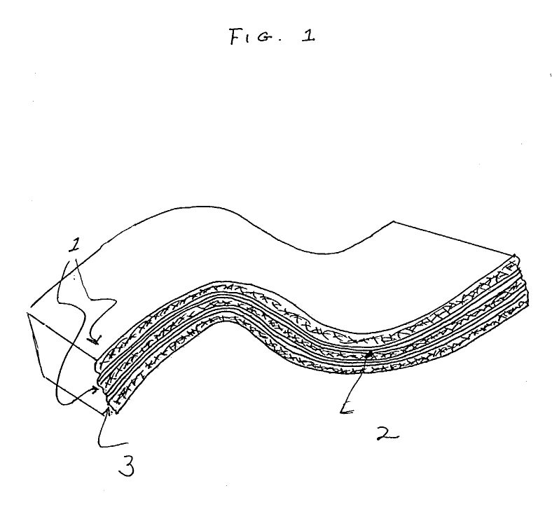

FIG. 1 shows a middle section of an embodiment of the invention. It comprises several layers of two-dimensional knit fabric 1, interleaved and bonded together by adhesive layers 2, 3. Each two-dimensional knit fabric 1 is “two-dimensional”, because each layer by itself does not have a significant z-component. When, however, several layers of two-dimensional knit fabric 1 are bonded together, the middle section can have a significant z-direction component, and can be considered a “three-dimensional fabric structure”. In some embodiments, a single three-dimensional fabric structure can include one or more three-dimensional fabrics, or two or more two-dimensional fabrics.

The adhesive layers 2, 3 may comprise the same or different adhesive materials. For example, the adhesive layer 2 may include a light, elastic fabric adhesive such as latex, or urethane. The adhesive layer 3 may comprise a light, elastic, adhesive, polymer film comprising, for example, a polyethylene, polyvinylchloride, polyolefin, or polyurethane. Each of the adhesive layers 2, 3 may have a thickness of about 1 mm or less. Each adhesive layer 2, 3 could also have one or more sublayers.

Each two-dimensional knit fabric 1 may comprise elastic yarns or fibers such as those produced under the tradename Lycra™ spandex by E. I. DuPont de Nemours and Co., of Wilmington, Del. Elastic fibers such as spandex can be used alone or in combination with other types of fibers or yarns in the middle section.

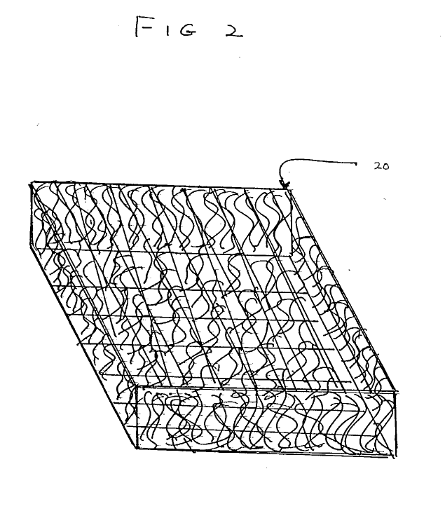

FIG. 2 is a middle section according to another embodiment of the invention. It is composed of a three-dimensional continuously knitted or woven fabric as produced either on a double needle-bar warp knitter, or circular needle-bed weft knitter to produce a fabric with stretch. The three-dimensional fabric illustrated in FIG. 2 has a noticeable z-direction component as compared to “two-dimensional fabrics” which do not have a major z-direction component. Also, unlike the two-dimensional fabrics described above, the illustrated three-dimensional fabric also includes z- or vertically oriented fibers or yarns that are interwoven with two dense outer x-y woven components. Since the three-dimensional nature is actually woven into the fabric, it can be referred to as a “spacer fabric”. Spacer fabrics can have two dense outer woven layers with horizontally oriented fibers that are separated by fibers that are substantially vertically oriented (with respect to the orientations of the dense outer woven layers).

In the above-described three-dimensional fabric, the substantially vertically oriented fibers can be in the form of yarns and are sometimes referred to as pile yarns, while the yarns in the two outer woven layers include ground yarns. The pile yarns are preferably stiffer than the ground yarns, yet are sufficiently flexible and resilient to optimize the desired properties of compressibility and resiliency of the spacer fabric. Such spacer fabrics can be commercially obtained from Gehring Textiles, of New York, N.Y. and Beverley Knit, Inc. of North Carolina. A warp knitted textile spacer fabric is described in U.S. Pat. No. 5,385,036. This U.S. Patent is herein incorporated by reference in its entirety for all purposes.

In some embodiments, a knitted stretch spacer material includes the use of spandex for stretch and compression resistance, without increasing weight. The material has improved drape and comformability and can be further processed. For example, it can be laminated to an impermeable layer using a lamination and/or coating process, to provide a liquid and vapor impermeable composite fabric material suitable for diving and wet suit applications. The knitted spacer material can be formed with a face surface and a back surface in spaced apart relation with a body portion constructed therebetween, wherein the fabric further includes a stretch yarn component for increased stretch and compression resistance.

By way of example, a knitted stretch spacer material that is further processed via lamination, specifically having lamination on one of either the face or back surface, wherein the knitted stretch spacer material is manufactured by Beverly Knits, Inc. under the sample number BK 3595 Heavy at 22 oz/sq. yd, or under the sample number BK 3571 Light—19 oz/sq. yd, having a non-laminated weights of 21 oz/sq. yd and 16.7 oz/sq. yd, respectively. The lamination used is a commercially available Shawmut one-sided laminate at approximately 1-2 ounces. After lamination, the equivalent neoprene is about 32-42 ounces per square yard.

Middle sections comprising one or more three-dimensional fabrics are advantageous. First, the dense outer woven layers are particularly suitable for receiving an adhesive. An adhesive can be coated on the outer woven layers without penetrating into the region occupied by the vertically oriented fibers. This prevents the interior of the three-dimensional fabric from becoming saturated with adhesive during the composite fabrication process. If the interior becomes saturated with adhesive, the final composite may become inflexible. The middle section that is used in embodiments of the invention is still flexible and elastic, even after it is adhesively bonded to other layers. Second, three-dimensional fabrics are preferred as they provide good insulating properties. Three-dimensional fabrics have more dead air space than two-dimensional fabrics. Third, three-dimensional fabrics can maintain their structural integrity when exposed to external pressure and can also stretch.

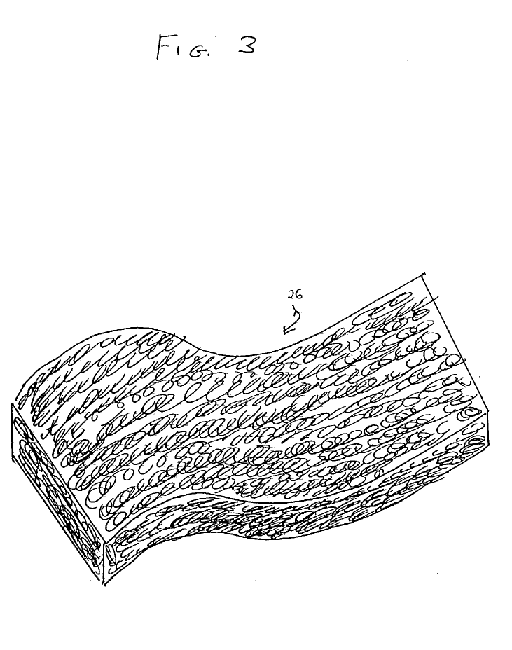

FIG. 3 shows an alternative middle section embodiment in the form of a single middle layer. It comprises a non-woven fabric (or it could alternatively be an open cell structure such as an open cell foam). Materials that can be used in this middle section resistance, elasticity and high dead air space, low modulus, and low weight. Preferably, the middle section shown in FIG. 3 is free of neoprene.

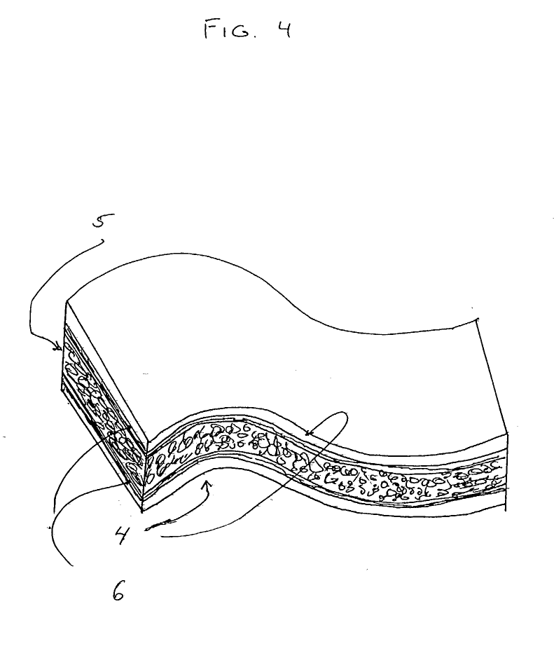

FIG. 4 shows yet another middle section embodiment in the form of two layers of two-dimensional knitted or woven fabric 4 and a single layer of non-woven fabric 5 (or an open cell structure) in combination. This combination provides the desired insulating properties of the middle section. Interleaved between these fabric layers are adhesive films 6. The adhesive films may comprise adhesives including urethanes, polyvinylchloride, polyethylene or polyolefins. The adhesive films 6 can have a thickness of not more than about 1 mm. In this embodiment, the adhesive films 6, the two-dimensional knitted or woven fabric 4 and the single layer of non-woven fabric 5 are free of neoprene.

The adhesive films 6 in the middle section in FIG. 4 (or in any other embodiment) can comprise a thermoplastic adhesive material, and may be formed in any suitable manner including roller coating, doctor blade coating, spray coating, lamination, etc. The adhesive films 6 can be cured using heat, radiation (e.g., UV radiation), etc. The amount of adhesive 6 and the manner of application of the adhesive can vary. Preferably, the adhesive 6 is applied in a pattern on the non-woven layer 5 and does not saturate the nonwoven fabric layer 5. Saturating the non-woven fabric layer 5 with a curable adhesive can inhibit it from stretching. In other embodiments, the adhesive layers between the barrier layers and the middle section may be discontinuous adhesive layers, instead of continuous films. This discontinuous adhesive layers may include dots or stripes of adhesive material in a layer.

The middle section may have any suitable characteristics. In the middle section embodiments shown in FIGS. 1-5, the dead air space of each middle section is preferably not less than about 15% of the total volume occupied by the middle layer. The high volume of dead air space in the middle section provides the composite fabric material with good insulating properties. The middle section can also be thin. For example, in some embodiments, the total thickness of the middle section can be greater than about 2 mm and not more than about 20 mm. The denier of the yarns in the middle section may vary depending on the desired weight and/or intended end use. For example, the denier of the yarns can be from approximately about 10 to about 1000 denier and, and preferably between about 25 and about 250 denier.

Apparel fibers from any number of sources can be in the middle section. Examples include plainly woven materials, knitted materials, spun or monofilaments, multifilaments, texturized fibers and fabrics, and fibrillated or fully oriented fibers. Materials that can be used in the fibers may include polyester, polyether, nylon, cotton, fleece, rayon, cotton, acetate, acrylic, viscose polymers, vinyl-type polymers, polypropylene, polyvinylchloride, polytetrafluroethylene, polyolefin, flax, and metallic oxides. Elastomeric materials such as Lycra™ spandex may also be used in the middle section. In some embodiments, a spacer fabric can be constructed of 80% (by volume) polyester and 20% spandex material. The resulting fabric has a stretch of at least about 100% on the x and y axes, and a stretch of at least about 50% on a diagonal to the x and y axes.

The middle section embodiments shown in FIGS. 1-5 can have other properties that are particularly suited for wetsuit-like applications. For instance, the elasticity of the middle section can be at least about 100% on one axis and about 50% and on another axis (e.g., warp and weft). In other embodiments, the elasticity of the middle section can be at least about 150% (e.g., about 400%) on one axis and at least about 100% on another axis (e.g., warp and weft). In embodiments of the invention, the middle section can have high elasticity in any suitable direction (e.g., a diagonal direction to x and y axes). The compression resistance of the middle section (or the composite fabric material) can be greater than about 5 psi and less than about 150 psi. Preferably, the compression resistance is in the range of about 20 to about 50 psi for diving garments and less than about 15 psi for surfing wetsuits. In embodiments of the invention, “compression resistance” refers to the ability of the composite fabric material (or layers therein) to distribute pressure evenly when the material is submerged and thereby withstand complete compression at a given pressure.

The composite fabric material can also be lightweight. For example, the weight per square yard of the materials in the middle section can be less than about 40 ounces, about 30 ounces, or about 15 ounces per square yard. It can have a low resistance to stretch (e.g., a low elastic modulus) so that a wearer of the composite fabric material can move with ease. For example, the elastic modulus of the middle section (or the composite fabric material) can be between about 0.75 to about 1.65 lbs/ft in some embodiments of the invention. Embodiments of the invention can also have high recovery after stretching. For example, in some embodiments of the invention, the % recovery of the middle section (or the composite fabric material) after stretching is greater than about 90%.

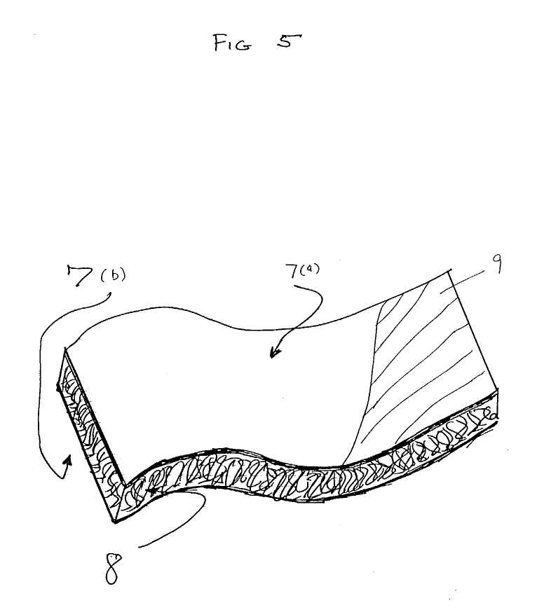

FIG. 5 shows a composite fabric material according to an embodiment of the invention. FIG. 5 shows barrier layers 7(a), 7(b) affixed to an insulating middle section 8. Any suitable method may used to adhere the barrier layers 7(a), 7(b) to the middle section 8. In some embodiments, the barrier layers 7(a), 7(b) could be formed on the middle section 8 after the middle section is formed. Exemplary methods include laminating an extruded film, spray coating, and so forth. In other embodiments, the barrier layers 7(a), 7(b) could also be pre-formed and then laminated to a pre-formed middle section 8. Adhesive layers may be provided on the pre-formed barrier layers 7(a), 7(b) and/or the pre-formed middle section 8 prior to lamination.

The barrier layers 7(a), 7(b) may have any suitable properties. For example, the barrier layers 7(a), 7(b) are preferably substantially water vapor and liquid water impermeable and exhibit high abrasion resistance. They can also have high elasticity, a low modulus, low weight, excellent memory and UV (ultraviolet) resistance. In some embodiments, the barrier layers 7(a), 7(b) may also be less than about 4 mm thick and are formulated to so that they are substantially impermeable to water vapor and liquid water. For example, the barrier layers 7(a), 7(b) can block the free transmission of water vapor.

The barrier layers 7(a), 7(b) may comprise any suitable material. For example, the barrier layers 7(a), 7(b) can comprise natural or synthetic polymer films. Examples of materials include synthetic or natural rubber, polycarbonate-urethane, polyethylene, polyvinylchloride, polyolefin, and polystyrene-polyurethane, polysiloxane, polysulfane, polytetrafluoroethylene, polypropylene and polycarbonate and combinations of these and/or in combination with oxides of titanium, silver, copper, magnesium or aluminum. The barrier layers 7(a), 7(b) could also include copolymers (e.g., block copolymers) of the above or different polymers, blends, etc. Metal oxide particles such as titanium oxide can act as UV resistance agents and can be incorporated into one or both of the barrier layers 7(a), 7(b) to provide the composite fabric material with UV resistance.

The elastic and structural properties of the barrier layers 7(a), 7(b) are preferably similar to the elastic properties of the middle section 8. For instance, the elasticity of one or both of the barrier layers 7(a), 7(b) can be at least about 100% on one axis and about 50% on another axis. In other embodiments, the elasticity of the barrier layers 7(a), 7(b) can be at least about 150% (e.g., about 400%) on one axis and at least about 100% on an opposite axis. The barrier layers 7(a), 7(b) can also have a low resistance to stretch (e.g., a low elastic modulus) to provide ease of movement for the wearer. For example, the elastic modulus of each of the barrier layers 7(a), 7(b) can be between about 0.75 to about 1.65 lbs/ft in some embodiments of the invention. Also, in preferred embodiments of the invention, the % recovery after stretching of each or both of the barrier layers 7(a), 7(b) can be greater than about 90%.

Preferably, at ambient temperature and pressure, the pressure of the dead air space between the barrier layers 7(a), 7(b) is at ambient pressure. This makes the composite fabric material easier to fabricate and use.

FIG. 5 also shows a largely decorative outer layer 9. In some embodiments, the outer decorative layer 9 may comprise nylon or spandex. The decorative outer layer 9 may be further affixed to the barrier layer 7 by means commonly known to the art. For example, the decorative outer layer 9 can be stitched on, or could be adhered to a barrier layer using an adhesive.

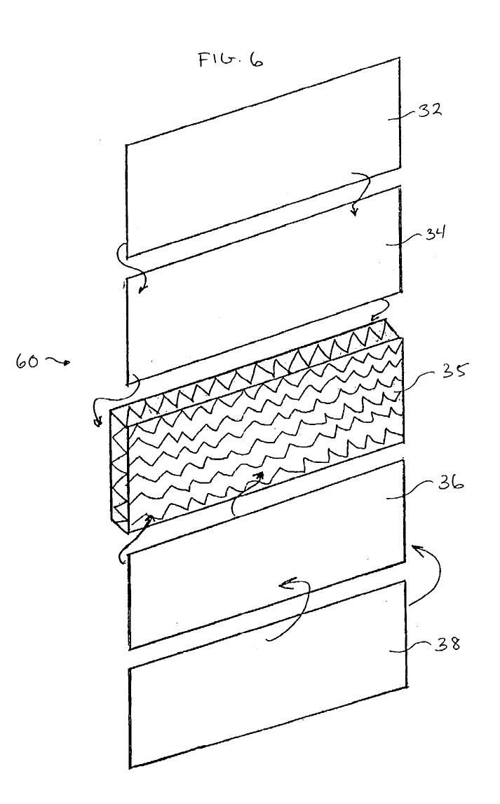

FIG. 6 shows a schematic view of five-layers in a composite fabric material according to another embodiment of the invention. It includes a lightweight, elastic fabric outer layer 32 comprising a material such as nylon or spandex. It may be a knitted layer. An outer barrier layer 34 and an inner barrier layer 36 sandwich a three-dimensional fabric 35. The barrier layers 34, 36 and the three-dimensional fabric 35 may have any of the above-described materials or the above-described characteristics. Inner layer 38 may comprise a lightweight elastic fabric such as spandex, nylon or other skin-compatible fabric. Intervening adhesive layers (not shown) such as those described above can be used to bond the five illustrated layers together to form a composite fabric material.

The composite fabric material according to embodiments of the invention can be used in any suitable application including applications where the wearer is exposed to water. For example, the composite fabric material can be used to make waterproof hoods, gloves, booties, and wetsuits. A suitable wetsuit can include sleeves, pant legs, zippers, etc.

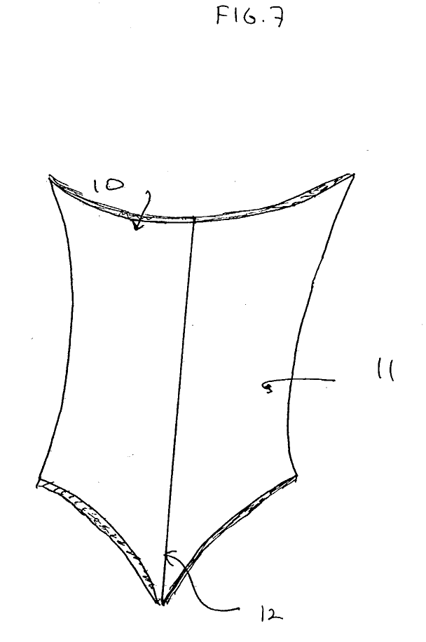

FIG. 7 shows the composite fabric material in garment panels 10 and 11, which are joined into a hermetically sealed suit section. The suit seams are made waterproof and strong by means including thermal bonding, radio frequency or ultrasonic welding, gluing, blind stitching, laser fusion, and other techniques. Other seam forming processes that can be used in embodiments of the invention are described in U.S. patent application Ser. No. 09/166,427, filed on Oct. 5, 1998, U.S. patent application Ser. No. 10/079,779, filed on Feb. 19, 2002, and U.S. Pat. No. 3,686,064, which are all herein incorporated by reference in their entirety for all purposes.

Although the barrier layers and the middle section are described herein in detail, it is understood that other embodiments of the invention could include other layers or sections in addition to these layers and sections. For example, in some embodiments, additional fabric layers may be provided to add comfort to the skin. An inner layer comprising, for example raised fleece could be provided on the inner side of the composite fabric material to provide a wearer with comfort. In yet other embodiments, additional outer layers could be added to improve tear or puncture resistance. Dense nylon or polyester layers may be suitable for this purpose. An outer layer could also be provided to provide the composite fabric material with UV resistance.

The terms and expressions which have been employed herein are used as terms of description and not of limitation, and there is no intention in the use of such terms and expressions of excluding equivalents of the features shown and described, or portions thereof, it being recognized that various modifications are possible within the scope of invention the claimed. Moreover, one or more features of one or more embodiments of the invention may be combined in any suitable manner without departing from the spirit and the scope of the invention.

What is claimed is:

1. A composite fabric material comprising:
a middle section comprising a three-dimensional fabric structure with a first surface and a second surface;
a first barrier layer proximate the first surface, wherein the first barrier layer is substantially impermeable to water vapor and liquid water; and
a second barrier layer proximate the second surface, wherein the second barrier layer is substantially impermeable to water vapor and liquid water.

2. The composite fabric material of claim 1, wherein a dead air space of the middle section is not less than 15% of the total volume occupied.

3. The composite fabric material of claim 1, wherein an elasticity of the three-dimensional fabric structure is not less than about 100% along a first axis and not less than about 50% along a second axis.

4. The composite fabric material of claim 1, wherein a compression resistance of the three-dimensional fabric structure is not less than about 5 psi and not more than about 150 psi.

5. The composite fabric material of claim 1, wherein the three-dimensional fabric structure comprises a three-dimensional fabric that includes a yarn between the first and second surfaces, and wherein the denier of the yarn is from about 10 to about 1000 denier.

6. The composite fabric material of claim 1, wherein a total thickness of the three-dimensional fabric structure is not less than about 2 mm and not more than about 20 mm.

7. The composite fabric material of claim 1, wherein the three-dimensional fabric structure has a weight per square yard of not more than about 40 ounces.

8. The composite fabric material of claim 1, wherein a total thickness of the composite fabric material is not more than about 4 mm.

9. The composite fabric material of claim 1, wherein the weight per square yard of the barrier layer is not more than 8 ounces.

10. The composite fabric material of claim 1, wherein the three-dimensional fabric structure comprises a three-dimensional fabric including two outer woven layers which are separated by substantially vertically oriented fibers.

11. The composite fabric material of claim 1, wherein each of the barrier layers has an elasticity that is not less than about 100% along a first axis and not less than about 50% along a second axis.

12. The composite fabric material of claim 1, wherein the barrier layers are hydrophobic.

13. The composite fabric material of claim 1, wherein the first and second barrier layers include a material selected from a group consisting of polycarbonate-urethane, polyethylene, polyvinylchloride, polyolefin, and polystyrene-polyurethane, polysiloxane, polysulfane, polytetrafluoroethylene, polypropylene, polycarbonate, block copolymers and blends thereof, optionally in combination with oxides selected from a group consisting of titanium, copper, silver, magnesium or aluminum.

14. The composite fabric material of claim 1 wherein the middle section comprises two or more layers of three-dimensional fabric.

15. A composite fabric material comprising:
a middle section comprising a two-dimensional fabric including a first surface and a second surface;
a first barrier layer which is substantially impermeable to water vapor and liquid water and is adhered to the first surface of the middle section; and
a second barrier layer that is substantially impermeable to water vapor and liquid water and is adhered to the second surface of the middle section,
wherein the composite fabric material is substantially free of neoprene.

16. The composite fabric material of claim 15, wherein a dead air space of the middle section is not less than 15% of the total volume occupied by the middle section.

17. The composite fabric material of claim 15, wherein an elasticity of the middle section is not less than about 100% along a first axis not less than about 50% along a second axis.

18. The composite fabric material of claim 15, wherein a compression resistance of the middle section is not less than about 5 psi and not more than about 150 psi.

19. The composite fabric material of claim 15, wherein the middle section includes a yarn, and the denier of the yarn is from about 10 to about 1000 denier.

20. The composite fabric material of claim 15, wherein a total thickness of the middle section is not less than about 2 mm and not more than about 20 mm.

21. The composite fabric material of claim 15, wherein a weight per square yard of the middle section is not more than about 40 ounces.

22. The composite fabric material of claim 15, wherein the total thickness of each of the first and second barrier layers is not more than about 4 mm.

23. The composite fabric material of claim 15, wherein a weight per square yard of each of the first and second barrier layers is not more than about 8 ounces.

24. The composite fabric material of claim 15, wherein an elasticity of each of the first and second barrier layers is not less than about 100% along a first axis and not less than about 50% along a second axis.

25. The composite fabric material of claim 15, wherein each of the first and second barrier layers is hydrophobic.

26. The composite fabric material of claim 15, wherein each of the first and second barrier layers includes a material selected from a group consisting of polycarbonate-urethane, polyethylene, polyvinylchloride, polytetrafluoroethylene, polyolefin, and polystyrene-polyurethane, polysiloxane, polysulfane, polypropylene and polycarbonate, and co-polymers and blends thereof, optionally in combination with oxides selected from a group consisting of titanium, silver, copper, magnesium and aluminum.

27. The composite fabric material of claim 15 wherein the middle section further comprises a second layer of two-dimensional fabric.

28. The composite fabric material of claim 15 wherein the two-dimensional fabric comprises a non-woven fabric.

29. A waterproof garment comprising:
the composite fabric of claim 1.

30. The waterproof garment of claim 29 wherein the garment is assembled using glue, a combination of glue and sewing, radio frequency welding, ultrasonic welding, or any combination thereof to form durable and elastic seams which are liquid water and water vapor impermeable.

31. The waterproof garment of claim 29 wherein the waterproof garment is a wetsuit, a waterproof glove, or a waterproof hood.

32. A waterproof garment comprising:
the composite fabric of claim 15.

33. The waterproof garment of claim 32 wherein the garment is assembled using glue, a combination of glue and sewing, radio frequency welding, ultrasonic welding, or any combination thereof to form durable and elastic seams which are liquid water and water vapor impermeable.

34. The waterproof garment of claim 32 wherein the waterproof garment is a wetsuit, a waterproof glove, or a waterproof hood.

35. A composite fabric material comprising:
(a) a middle section comprising three-dimensional fabric with a first surface and a second surface and comprising elastomeric fibers;
(b) a first elastic barrier layer proximate the first surface, wherein the first elastic barrier layer is impermeable to water vapor and liquid water;
(c) a second elastic barrier layer proximate the second surface, wherein the second elastic barrier layer is impermeable to water vapor and liquid water;
(d) a first adhesive layer coupling the middle section and the first elastic barrier layer; and
(e) a second adhesive layer coupling the second elastic barrier layer and the middle section.

36. The composite fabric according to claim 35 wherein at least one of the three-dimensional fabric, the first elastic barrier layer, and the second elastic barrier layer has an elasticity of at least about 100% in a direction.

37. The composite fabric according to claim 35 wherein all of (a)-(c) have an elasticity of at least about 100% in at least one direction.

38. A waterproof garment comprising:
a composite fabric material including (a) a middle section comprising a three-dimensional fabric with a first surface and a second surface and comprising elastomeric fibers, (b) a first elastic barrier layer proximate the first surface, wherein the first elastic barrier layer is impermeable to water vapor and liquid water, (c) a second elastic barrier layer proximate the second surface, wherein the second elastic barrier layer is impermeable to water vapor and liquid water, (d) a first adhesive layer coupling the middle section and the first elastic barrier layer, and (e) a second adhesive layer coupling the second elastic barrier layer and the middle section.

39. The waterproof garment of claim 38 wherein the waterproof garment is a wetsuit.

40. The waterproof garment of claim 38 wherein the first and second elastic barrier layers each comprise metal oxides.

41. The waterproof garment of claim 38 further comprising a decorative outer layer on the second elastic barrier layer.
